(19) United States
(12) Patent Application Publication
(10) Pub. No.: US 2018/0330140 A1
(43) Pub. Date: Nov. 15, 2018

(54) FINGERPRINT IDENTIFICATION APPARATUS

(71) Applicant: Gingy Technology Inc., Hsinchu City (TW)

(72) Inventors: Patrick Lin, Hsinchu City (TW); Jen-Chieh Wu, Hsinchu City (TW)

(73) Assignee: Gingy Technology Inc., Hsinchu City (TW)

(21) Appl. No.: 16/027,286

(22) Filed: Jul. 4, 2018

Related U.S. Application Data
(63) Continuation-in-part of application No. 14/822,891, filed on Aug. 10, 2015, now Pat. No. 10,061,964.
(60) Provisional application No. 62/067,966, filed on Oct. 23, 2014.
(60) Provisional application No. 62/563,045, filed on Sep. 25, 2017.
(60) Provisional application No. 62/574,222, filed on Oct. 19, 2017.

(30) Foreign Application Priority Data
Feb. 1, 2018 (CN) 201820172153.8

(51) Int. Cl. G06K 9/00; G02B 6/42

(52) U.S. Cl. CPC G06K 9/0004; G02B 6/4298

(57) ABSTRACT

A fingerprint identification apparatus including a light guide element, a transparent substrate, a light source, and an image-sensing element is provided. The light guide element has a first surface, a second surface opposite the first surface, and a side connected between the first surface and the second surface. The transparent substrate is disposed on the first surface of the light guide element and has a pressing surface to be pressed by a finger. The light source is configured to emit a light beam and is disposed adjacent to the side of the light guide element. The image-sensing element is disposed opposite to the second surface of the light guide element. The pressing surface of the transparent substrate or the second surface of the light guide element is an irregular rough surface.

### CROSS-REFERENCE TO RELATED APPLICATION

This application is a continuation-in-part application of and claims the priority benefit of U.S. application Ser. No. 14/822,891, filed on Aug. 10, 2015, now pending, which claims the priority benefits of U.S. provisional application Ser. No. 62/067,966, filed on Oct. 23, 2014. This application also claims the priority benefits of U.S. application Ser. No. 62/563,045, filed on Sep. 25, 2017, U.S. application Ser. No. 62/574,222, filed on Oct. 19, 2017, and China application serial no. 201820172153.8, filed on Feb. 1, 2018. The entirety of each of the above-mentioned patent applications is hereby incorporated by reference herein and made a part of this specification.

### BACKGROUND OF THE INVENTION

### Field of the Invention

The invention relates to an optoelectronic apparatus, and more particularly, to a fingerprint identification apparatus.

### Description of Related Art

Fingerprint recognition is the mainstream technique of current biometrics, and can mainly be divided into capacitive and optical. An optical fingerprint identification apparatus includes a light guide element and an image-capture element. The light guide element is configured to transmit a light beam, and the image capture element is configured to capture an image of a fingerprint. The fingerprint of a finger has a plurality of irregular peaks and troughs, and when a light beam is irradiated on the peaks and troughs of the fingerprint, the light beam is reflected on the light-receiving surface of the image-capture element to form a stripe pattern with interleaved light and dark regions. Lastly, a corresponding image information is calculated using an algorithm to achieve the function of fingerprint recognition.

To make the light beam reflected by the fingerprint incident on the light-receiving surface of the image-capture element in a more collimated manner, a plurality of optical microstructures is placed on a surface of the light guide element. Although the optical microstructures can adjust the transmission path of the light beam reflected by the fingerprint, the plurality of optical microstructures is periodically arranged. When the light beam reflected by the fingerprint passes through the plurality of periodically-arranged optical microstructures, the light beam originally carrying a complete fingerprint image is damaged by the periodically-arranged optical microstructures. As a result, image capture quality is affected, which is counterproductive to fingerprint recognition.

### SUMMARY OF THE INVENTION

The invention provides a fingerprint identification apparatus that can obtain a fingerprint image with good quality.

The fingerprint identification apparatus of the invention includes a light guide element, a transparent substrate, a light source, and an image-sensing element. The light guide element has a first surface, a second surface opposite the first surface, and a side connected between the first surface and the second surface. The transparent substrate is disposed on the first surface of the light guide element and has a pressing surface to be pressed by a finger. The light source is configured to emit a light beam and is disposed adjacent to the side of the light guide element. The image-sensing element is disposed opposite to the second surface of the light guide element. The light beam sequentially enters the light guide element from the side of the light guide element, passes through the pressing surface of the transparent substrate, is reflected by the finger located on the pressing surface, and passes through the transparent substrate and the first surface and the second surface of the light guide element to be transmitted to the image-sensing element. In particular, the pressing surface of the transparent substrate or the second surface of the light guide element is an irregular rough surface.

In an embodiment of the invention, the pressing surface of the transparent substrate is the irregular rough surface, and a roughness of the pressing surface of the transparent substrate is greater than a roughness of the second surface of the light guide element.

In an embodiment of the invention, the second surface of the light guide element is the irregular rough surface, and a roughness of the second surface of the light guide element is greater than a roughness of the pressing surface of the transparent substrate.

In an embodiment of the invention, the second surface of the light guide element has a plurality of microstructures, the pressing surface of the transparent substrate is the irregular rough surface, and a roughness of the second surface of the light guide element is greater than a roughness of the pressing surface of the transparent substrate.

In an embodiment of the invention, the microstructures of the second surface of the light guide element are regularly arranged.

In an embodiment of the invention, a roughness of the irregular rough surface is greater than 0.001 microns and less than 1 micron.

The fingerprint identification apparatus of the invention includes a light guide element, a plurality of scattering particles, a transparent substrate, a light source, and an image-sensing element. The light guide element has a first surface, a second surface opposite the first surface, and a side connected between the first surface and the second surface. The plurality of scattering particles is distributed in the light guide element. The transparent substrate is disposed on the first surface of the light guide element and has a pressing surface to be pressed by a finger. The light source is configured to emit a light beam and is disposed adjacent to the side of the light guide element. The image-sensing element is disposed opposite to the second surface of the light guide element. The light beam sequentially enters the light guide element from the side of the light guide element, is scattered toward the pressing surface of the transparent substrate by the scattering particles, is reflected by the finger located on the pressing surface, and passes through the transparent substrate and the light guide element to be transmitted to the image-sensing element.

In an embodiment of the invention, the second surface of the light guide element has a plurality of microstructures, and a roughness of the second surface of the light guide element is greater than a roughness of the pressing surface of the transparent substrate and the roughness of the first surface of the light guide element.

In an embodiment of the invention, a roughness of the second surface of the light guide element is greater than 0.010 microns and less than 10 microns.

Based on the above, in the fingerprint identification apparatus of an embodiment of the invention, the pressing surface of the transparent substrate or the second surface of the light guide element is the irregular rough surface. Via the aperiodic structure distribution of the rough surface, after the light beam reflected by the finger passes through the rough surface, the light beam does not carry an image information having a corresponding periodic structure and interfere with the fingerprint information originally carried by the light beam. Accordingly, the image-sensing element can obtain a clear fingerprint image of the finger to facilitate fingerprint recognition.

A plurality of scattering particles is placed in the light guide element of the fingerprint identification apparatus of another embodiment of the invention. After the light beam reflected by the finger passes through the light guide element, the light beam is scattered by the scattering particles in the light guide element and does not carry an image information having a corresponding periodic structure and interfere with the fingerprint information originally carried by the light beam. Accordingly, the image-sensing element can obtain a clear fingerprint image of the finger to facilitate fingerprint recognition.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross section of a fingerprint identification apparatus of an embodiment of the invention.

FIG. 2 is a cross section of a fingerprint identification apparatus of another embodiment of the invention.

FIG. 3 is a cross section of a fingerprint identification apparatus of yet another embodiment of the invention.

FIG. 4 is a cross section of a fingerprint identification apparatus of still yet another embodiment of the invention.

FIG. 5 is a cross section of a fingerprint identification apparatus of an embodiment of the invention.

### DESCRIPTION OF THE EMBODIMENTS

Hereinafter, exemplary embodiments are described in detail, and examples of the exemplary embodiment are conveyed via the figures. Wherever possible, the same reference numerals are used in the drawings and the descriptions to refer to the same or similar portions.

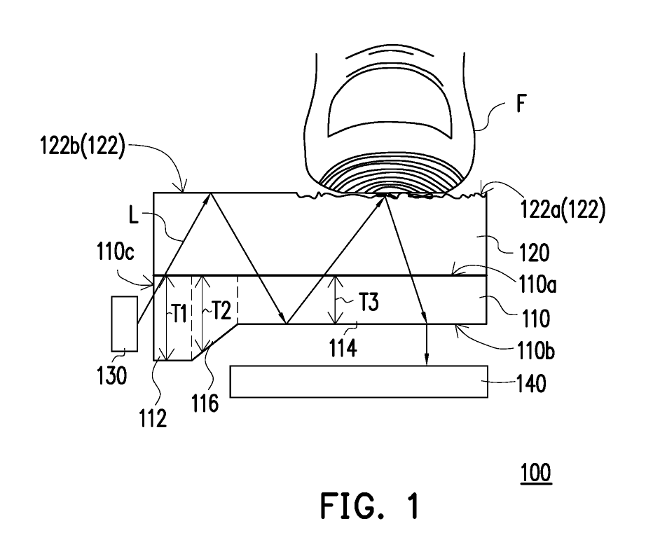

FIG. 1 is a cross section of a fingerprint identification apparatus of an embodiment of the invention. Referring to FIG. 1, a fingerprint identification apparatus 100 includes a light guide element 110, a transparent substrate 120, a light source 130, and an image-sensing element 140. The light guide element 110 has a first surface 110a, a second surface 110b opposite the first surface 110a, and a side 110c connected between the first surface 110a and the second surface 110b. For instance, in the present embodiment, the light guide element 110 can include a light-coupling portion 112 adjacent to the light source 130 and having a side 110c and a light guide portion 114 away from the light source 130, wherein a thickness T1 of the light-coupling portion 112 is greater than a thickness T2 of the light guide portion 114. The light guide element 110 further includes a connecting portion 116, and the connecting portion 116 is connected between the light-coupling portion 112 and the light guide portion 114 and has a gradient thickness T3, wherein T2<T3<T1. However, the invention is not limited thereto, and in other embodiments, the light guide element 110 can also be designed to have other configurations. In the present embodiment, the material of the light guide element 110 is, for instance, polymethylmethacrylate (PMMA). However, the invention is not limited thereto, and in other embodiments, the material of the light guide element 110 can also be other suitable translucent materials.

The transparent substrate 120 is disposed on the first surface 110a of the light guide element 110 and has a pressing surface 122a to be pressed by a finger F. In the present embodiment, the light guide element 110 has an upper surface 122 away from the light guide element 110, and the pressing surface 122a refers to a portion of the upper surface 122 of the transparent substrate 120. In the present embodiment, the pressing surface 122a can be overlapped with the light guide portion 114 of the light guide element 110 and not be overlapped with the light-coupling portion 112 of the light guide element 110 and the connecting portion 116. For instance, in the present embodiment, the material of the transparent substrate 120 can be glass, and the transparent substrate 120 can be referred to as a cover glass. However, the invention is not limited thereto, and in other embodiments, the material of the transparent substrate 120 can also be other suitable materials having high transmittance that is resistant to pressing.

The light source 130 is configured to emit a light beam L and is disposed adjacent to the side 110c of the light guide element 110. The image-sensing element 140 is disposed opposite to the second surface 110b of the light guide element 110. The second surface 110b of the light guide element 110 is located between the first surface 110a of the light guide element 110 and the image-sensing element 140. In the present embodiment, the light source 130 is, for instance, a light-emitting diode (LED), and the image-sensing element 140 can be a charge-coupled device (CCD) sensor, a complementary metal-oxide-semiconductor (CMOS), or other types of sensors, but the invention is not limited thereto.

In the present embodiment, the upper surface 122 of the transparent substrate 120 can further have a non-pressing surface 122b other than the pressing surface 122a, wherein the non-pressing surface 122b is closer to the light source 130 than the pressing surface 122a. In the present embodiment, the light beam L sequentially enters the light guide element 110 from the side 110c of the light guide element 110, is reflected by the non-pressing surface 122b of the transparent substrate 120, passes through the first surface 110a of the light guide element 110, is reflected by the second surface 110b of the light guide element 110, passes through the pressing surface 122a of the transparent substrate 120, is reflected by the finger F located on the pressing surface 122a, and passes through the transparent substrate 120 and the first surface 110a and the second surface 110b of the light guide element 110 to be transmitted to the image-sensing element 140.

In the present embodiment, the pressing surface 122a of the transparent substrate 120 is an irregular rough surface, and the second surface 110b of the light guide element 110 is a smooth surface. The roughness of the pressing surface 122a is greater than the roughness of the second surface 110b of the light guide element 110. Specifically, in the present embodiment, the roughness of the irregular rough surface (such as the pressing surface 122a) is greater than 0.001 microns and less than 1 micron. Specifically, the roughness refers to the arithmetical mean deviation of the roughness profile (Ra), defined as the value obtained by dividing the sum of a surrounded area with the center line in a measuring length obtained on a surface contour curve as the axis by the measuring length. A greater value of roughness indicates greater roughness, and on the other hand, a smaller value of roughness indicates greater smoothness. Moreover, in the present embodiment, the upper surface 122 of the transparent substrate 120 does not need to be entirely rough. That is, the pressing surface 122a can be a rough surface, and the non-pressing surface 122b can be a smooth surface, but the invention is not limited thereto.

In the present embodiment, other optical elements such as a prism or a collimator can be further optionally disposed between the light guide element 110 and the image-sensing element 140 to further increase the quality of the obtained fingerprint image, but the invention is not limited thereto.

It should be mentioned that, via the aperiodic structure distribution of the rough surface (such as the pressing surface 122a), after the light beam L reflected by the finger F passes through the rough surface, the light beam L does not carry an image information having a corresponding periodic structure and interfere with the fingerprint information originally carried by the light beam L. Accordingly, the image-sensing element 140 can obtain a clear fingerprint image of the finger F to improve fingerprint recognition capability.

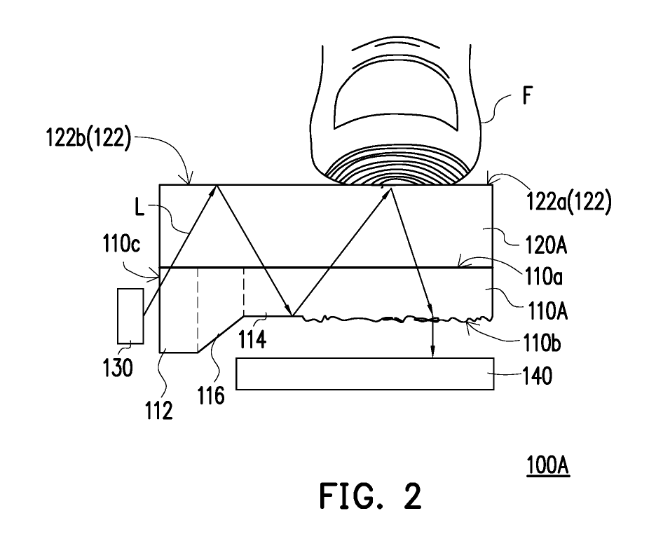

FIG. 2 is a cross section of a fingerprint identification apparatus of another embodiment of the invention. Referring to FIG. 1 and FIG. 2, a fingerprint identification apparatus 100A of FIG. 2 is similar to the fingerprint identification apparatus 100 of FIG. 1, and the main difference between the two is that the second surface 110b of a light guide element 110A is an irregular rough surface, and the pressing surface 122a of a transparent substrate 120A is a smooth surface. The fingerprint identification apparatus 100A has a similar efficacy as the fingerprint identification apparatus 100 and is therefore not repeated herein.

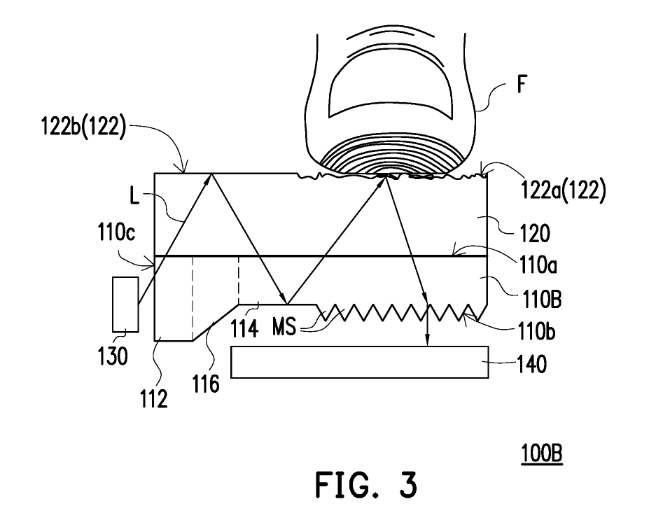

FIG. 3 is a cross section of a fingerprint identification apparatus of yet another embodiment of the invention. Referring to FIG. 1 and FIG. 3, a fingerprint identification apparatus 100B of FIG. 3 is similar to the fingerprint identification apparatus 100 of FIG. 1, and the difference between the two is that the second surface 110b of a light guide element 110B of the fingerprint identification apparatus 100B can be not smooth, and the second surface 110b can have a plurality of microstructures MS. In the present embodiment, the plurality of microstructures MS of the second surface 110b can be regularly arranged, and the roughness of the second surface 110b is greater than 0.010 microns and less than 10 microns. The roughness of the second surface 110b refers to the arithmetical mean deviation of the roughness profile (Ra), defined as the value obtained by dividing the sum of a surrounded area with the center line in a measuring length obtained on a surface contour curve as the axis by the measuring length, wherein the surface contour curve refers to the contour curve of the plurality of microstructures MS themselves and does not include the contour curve where the plurality of microstructures MS of the second surface 110b is not located, and the surrounded area refers to the area of the plurality of microstructures MS themselves and does not include the area where the plurality of microstructures MS of the second surface 110b is not located. For instance, in the present embodiment, the microstructures MS can be prisms, and the size of the angle formed by each of the microstructures MS can be the same or different. However, the invention is not limited thereto, and in other embodiments, the microstructures MS can also be semicircle columns or other suitable configurations. In the present embodiment, the microstructures MS can be equally spaced or not equally spaced, but the invention is not limited thereto.

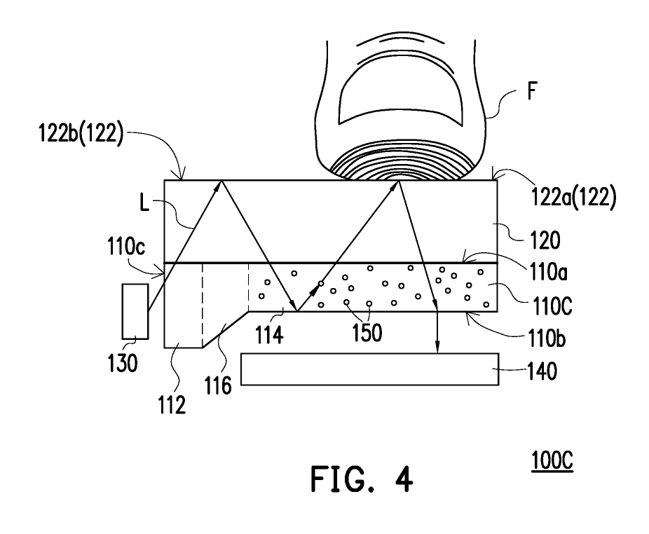

FIG. 4 is a cross section of a fingerprint identification apparatus of yet another embodiment of the invention. Referring to FIG. 4, a fingerprint identification apparatus 100C includes a light guide element 110C, scattering particles 150, a transparent substrate 120, a light source 130, and an image-sensing element 140. The light guide element 110C has a first surface 110a, a second surface 110b opposite the first surface 110a, and a side 110c connected between the first surface 110a and the second surface 110b. The transparent substrate 120 is disposed on the first surface 110a of the light guide element 110C and has a pressing surface 122a to be pressed by a finger F. The light source 130 is configured to emit a light beam L and is disposed adjacent to the side 110c of the light guide element 110C. The image-sensing element 140 is disposed opposite to the second surface 110b of the light guide element 110C. In the present embodiment, the second surface 110b of the light guide element 110C and the pressing surface 122a of the transparent substrate 120 can both be smooth surfaces, but the invention is not limited thereto.

It should be mentioned that, the plurality of scattering particles 150 is distributed in the light guide element 110C. For instance, in the present embodiment, the distribution density of the scattering particles 150 in the light guide portion 114 can be greater than the distribution density of the scattering particles 150 in the light-coupling portion 112 and/or the connecting portion 116. Specifically, in the present embodiment, the scattering particles 150 are mainly distributed in the light guide portion 114, and are almost not distributed in the light-coupling portion 112 and the connecting portion 116. However, the invention is not limited thereto, and in other embodiments, the scattering particles 150 can also be distributed in the light guide portion 114, the light-coupling portion 112, and the connecting portion 116; and the distribution density of the scattering particles 150 in the light guide portion 114, the distribution density of the scattering particles 150 in the light-coupling portion 112, and the distribution density of the scattering particles 150 in the connecting portion 116 can also be substantially the same.

In the present embodiment, the light beam L sequentially enters the light guide element 110C from the side 110c of the light guide element 110C, is reflected by the non-pressing surface 122b of the transparent substrate 120, passes through the transparent substrate 120, is reflected by the second surface 110b of the light guide element 110C, scattered toward the pressing surface 122a of the transparent substrate 120 by the scattering particles 150, reflected by the finger F located on the pressing surface 122a, and passes through the transparent substrate 120 and the light guide element 110C to be transmitted to the image-sensing element 140. Similarly, after the light beam L reflected by the finger F passes through the light guide element 110C, the light beam L is scattered by the scattering particles 150 in the light guide element 110C and does not cany an image information having a corresponding periodic structure and interfere with the fingerprint information originally carried by the light beam L. Accordingly, the image-sensing element 140 can obtain a clear fingerprint image of the finger F to facilitate fingerprint recognition.

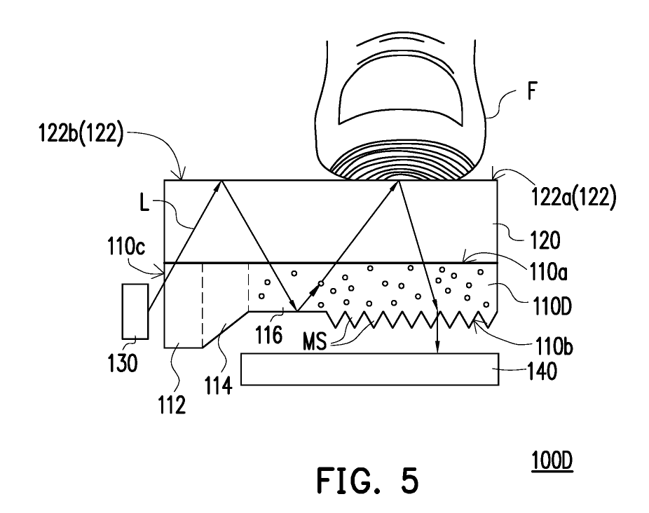

FIG. 5 is a cross section of a fingerprint identification apparatus of an embodiment of the invention. Referring to FIG. 4 and FIG. 5, a fingerprint identification apparatus 100D of FIG. 5 is similar to the fingerprint identification apparatus 100C of FIG. 4, and the difference between the two is that the second surface 110b of the light guide element 110D can have a plurality of microstructures MS. The fingerprint identification apparatus 100D has a similar efficacy as the fingerprint identification apparatus 100C and is therefore not repeated herein.

Based on the above, in the fingerprint identification apparatus of an embodiment of the invention, the pressing surface of the transparent substrate or the second surface of the light guide element is the irregular rough surface. Via the aperiodic structure distribution of the rough surface, after the light beam reflected by the finger passes through the rough surface, the light beam does not carry an image information having a corresponding periodic structure and interfere with the fingerprint information originally carried by the light beam. Accordingly, the image-sensing element can obtain a clear fingerprint image of the finger to facilitate fingerprint recognition.

A plurality of scattering particles is placed in the light guide element of the fingerprint identification apparatus of another embodiment of the invention. After the light beam reflected by the finger passes through the light guide element, the light beam is scattered by the scattering particles in the light guide element and does not carry an image information having a corresponding periodic structure and interfere with the fingerprint information originally carried by the light beam. Accordingly, the image-sensing element can obtain a clear fingerprint image of the finger to facilitate fingerprint recognition.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A fingerprint identification apparatus, comprising:
a light guide element having a first surface, a second surface opposite the first surface, and a side connected between the first surface and the second surface;
a transparent substrate disposed on the first surface of the light guide element and having a pressing surface to be pressed by a finger;
a light source configured to emit a light beam and disposed adjacent to the side of the light guide element; and
an image-sensing element disposed opposite to the second surface of the light guide element, wherein the light beam sequentially enters the light guide element from the side of the light guide element, passes through the pressing surface of the transparent substrate, is reflected by the finger located on the pressing surface, and passes through the transparent substrate and the first surface and the second surface of the light guide element to be transmitted to the image-sensing element;
and the pressing surface of the transparent substrate or the second surface of the light guide element is an irregular rough surface.

2. The fingerprint identification apparatus of claim 1, wherein the pressing surface of the transparent substrate is the irregular rough surface, and a roughness of the pressing surface of the transparent substrate is greater than a roughness of the second surface of the light guide element.

3. The fingerprint identification apparatus of claim 1, wherein the second surface of the light guide element is the irregular rough surface, and a roughness of the second surface of the light guide element is greater than a roughness of the pressing surface of the transparent substrate.

4. The fingerprint identification apparatus of claim 1, wherein the second surface of the light guide element has a plurality of microstructures, the pressing surface of the transparent substrate is the irregular rough surface, and a roughness of the second surface of the light guide element is greater than a roughness of the pressing surface of the transparent substrate.

5. The fingerprint identification apparatus of claim 4, wherein the microstructures of the second surface of the light guide element are regularly arranged.

6. The fingerprint identification apparatus of claim 4, wherein the roughness of the second surface of the light guide element is greater than 0.010 microns and less than 10 microns.

7. The fingerprint identification apparatus of claim 1, wherein a roughness of the irregular rough surface is greater than 0.001 microns and less than 1 micron.

8. A fingerprint identification apparatus, comprising:
a light guide element having a first surface, a second surface opposite the first surface, and a side connected between the first surface and the second surface;
a plurality of scattering particles distributed in the light guide element;
a transparent substrate disposed on the first surface of the light guide element and having a pressing surface to be pressed by a finger;
a light source configured to emit a light beam and disposed adjacent to the side of the light guide element; and
an image-sensing element disposed opposite to the second surface of the light guide element, wherein the light beam sequentially enters the light guide element from the side of the light guide element, is scattered by the scattering particles toward the pressing surface of the transparent substrate, reflected by the finger located on the pressing surface, and passes through the transparent substrate and the light guide element to be transmitted to the image-sensing element.

9. The fingerprint identification apparatus of claim 8, wherein the second surface of the light guide element has a plurality of microstructures, and a roughness of the second surface of the light guide element is greater than a roughness of the pressing surface of the transparent substrate and the roughness of the first surface of the light guide element.

10. The fingerprint identification apparatus of claim 9, wherein the roughness of the second surface of the light guide element is greater than 0.010 microns and less than 10 microns.
